(19) United States
(12) Patent Application Publication
(10) Pub. No.: US 2006/0235727 A1
(43) Pub. Date: Oct. 19, 2006

(54) KNOWLEDGE-BASED DISEASE MANAGEMENT SYSTEM TO COORDINATE AND IMPROVE PATIENT CARE

(76) Inventors: Michael G. Singer, (US); John D. Kutzko, (US)

Correspondence Address: IRVING M. WEINER;WEINER & BURT, P.C., 635 N. US-23, P.O. BOX 186, HARRISVILLE, MI, 48740, US

(21) Appl. No.: 11/277,171

(22) Filed: Mar. 22, 2006

Related U.S. Application Data
(60) Provisional application No. 60/594,268, filed on Mar. 24, 2005.

(51) Int. Cl. G06Q 10/00

(52) U.S. Cl. 705/2

(57) ABSTRACT

A knowledge-based disease management system and method to coordinate and improve patient care, including a repository of accumulated knowledge and experience from which outcome data are reported and compared.

The present patent application claims priority from and is a continuation in part of U.S. Provisional Patent Application Serial No. 60/594,268 filed Mar. 24, 2005.

The present invention relates generally to a novel and unique knowledge-based disease management system and method to coordinate and improve patient care.

More particularly, the present invention relates to a novel and unique knowledge-based disease management system or method to coordinate and improve patient care which is especially useful for complex disease conditions which require specialized management to assure continuity in the delivery of effective care.

### BACKGROUND OF THE INVENTION

Complex disease conditions require specialized management to assure continuity in the delivery of effective care.

Beyond the scope of the physician/patient relationship, other personnel and entities have entered or will enter into the process.

The expert management of pharmacotherapeutic interventions necessitates the introduction of additional patient management systems to adequately manage report and continually improve the specialized level of healthcare. The knowledge-based disease managements system and method in accordance with the present invention provides the organization, process and procedure to accomplish this. The experience of accumulated knowledge is used to improve the decision processes as well as potentially the importation of available knowledge components or data experience can be initially added.

The prior, but not necessarily relevant, art is exemplified by the following patent publications.

Ditrapano et al. International Publication Number WO 01/71641, entitled “PATIENT MEDICATION ASSESSMENT AND MANAGEMENT SYSTEM”, was published on Sep. 27, 2001.

Shewmake et al. U.S. Patent Application Publication Number US 2003/0208108, entitled, “CARDIOVASCULAR HEALTHCARE MANAGEMENT SYSTEM AND METHOD”, was published on Nov. 6, 2003.

McIvor U.S. Patent Application Publication Number US 2004/0059599, entitled, “PATIENT MANAGEMENT SYSTEM”, was published on Mar. 25, 2004.

It is a desideratum of the present invention to avoid the animadversions and deficiencies of the prior art, while providing a novel and unique knowledge-based disease management system and method to coordinate and improve patient care.

### SUMMARY OF THE INVENTION

The present invention provides a novel and unique knowledge-based disease management system to coordinate and improve patient care.

In particular, the present invention provides a knowledge-based disease management system to coordinate and improve patient care, comprising the steps of: providing a first or reference level which includes a knowledge base of published data concerning: a disease condition in question; drugs and agents available for said disease condition; metrics of assessing effectiveness, toxicity and adverse effects of said drugs and agents; progression of said disease condition; potential need for adjuvants, rescue therapies, and dose adjustment of said drugs and agents; and an inherent assessment and review mechanism to acquire new options or technologies or discard ineffective options on a monthly basis; providing a secondary level concerning delivery of active services on a managed schedule; providing a third level concerning active assessment of interventions to measure effectiveness of said interventions, patient compliance, and progression of said disease condition, and to report results of said active assessment of said interventions in relation to acceptable standards as defined in said first or reference level, providing a fourth level to modify said interventions based on findings of said third level to optimize a desired therapeutic effect and manage any toxic response, providing a fifth level to implement said modified interventions; repeating said third, fourth and fifth levels; and providing a sixth level as a repository of accumulated knowledge and experience of said system from which outcome data are reported and compared.

It is a primary object of the present invention to provide a knowledge-based disease management system and method to coordinate and improve patient care, especially for complex disease conditions which require highly specialized diagnostic, therapeutic and prognostic management systems to assure continuity in the delivery of effective care.

Another object of the present invention is to provide a knowledge-based disease management system and method as described hereinabove which also provides the organization, process and procedure to accomplish this.

Yet a further object of the present invention is to provide a knowledge-based disease management system and method as described hereinabove, which includes a first or reference level which contains the knowledge base of the published data on the disease condition in question, the ranked primary, secondary and tertiary drugs available for that system based upon their cost, effectiveness, availability and likely outcome, the metrics of assessing the effectiveness, toxicity or adverse effects of those drugs or agents, and the progression and prognosis of that particular disease condition as well as the potential need for adjuvants, rescue therapies and dose adjustment.

Yet a further object of the present invention is to provide a knowledge-based disease management system and method which includes a secondary level dealing with the delivery of active services on a therapeutically driven, calendarized management schedule inclusive of duties, responsibilities, times and follow-up for all parties.

Another object of the present invention is to provide a knowledge-based disease management system and method to coordinate and improve patient care as described hereinabove which includes a third level dealing with the active assessment of the interventions to measure their effectiveness (in regard to subjective and objective outcome metrics), patient compliance, and disease progression, and report those results in relation to acceptable standards as defined in the first or reference level.

A further object of the present invention is to provide a knowledge-based disease management system and method as described hereinabove, which, based on the findings of the third level the interventions are modified to optimize the desired therapeutic effect and then implemented.

Another object of the present invention is to provide a knowledge-based disease management system and method as described hereinabove, wherein, once the modified intervention is delivered and the results matured, the final level of re-evaluation is implemented.

Another object of the present invention is to provide a knowledge-based disease management system and method to coordinate and improve patient care, as described hereinabove, wherein once complete the system reverts to repeat levels three, four and five.

Another overall object of the present invention is a process to review and incorporate new data, clinical findings and technologies; assess their efficacy, applicability and contribution and incorporate them into the process.

The present invention possesses many advantages and features which will become more apparent to those persons skilled in this particular area of technology and to other persons after having been exposed to the detailed description set forth hereinbelow when read in conjunction with the accompanying drawing.

### BRIEF DESCRIPTION OF THE DRAWINGS

FIG. 1 illustrates for an embodiment of the invention the contents of the database, and the activity flow in the form of a flow chart.

FIG. 2 is a main flow diagram of a disease system management for a patient with a non-small cell lung cancer.

FIG. 3 shows the diagnosis, therapeutic and prognosis process tools for the disease management system for the patient with a non-small cell lung cancer.

FIG. 4 shows treatment options I, I, III of cycle dose regimens for the patient with the non-small cell lung cancer.

### DETAILED DESCRIPTION OF THE INVENTION

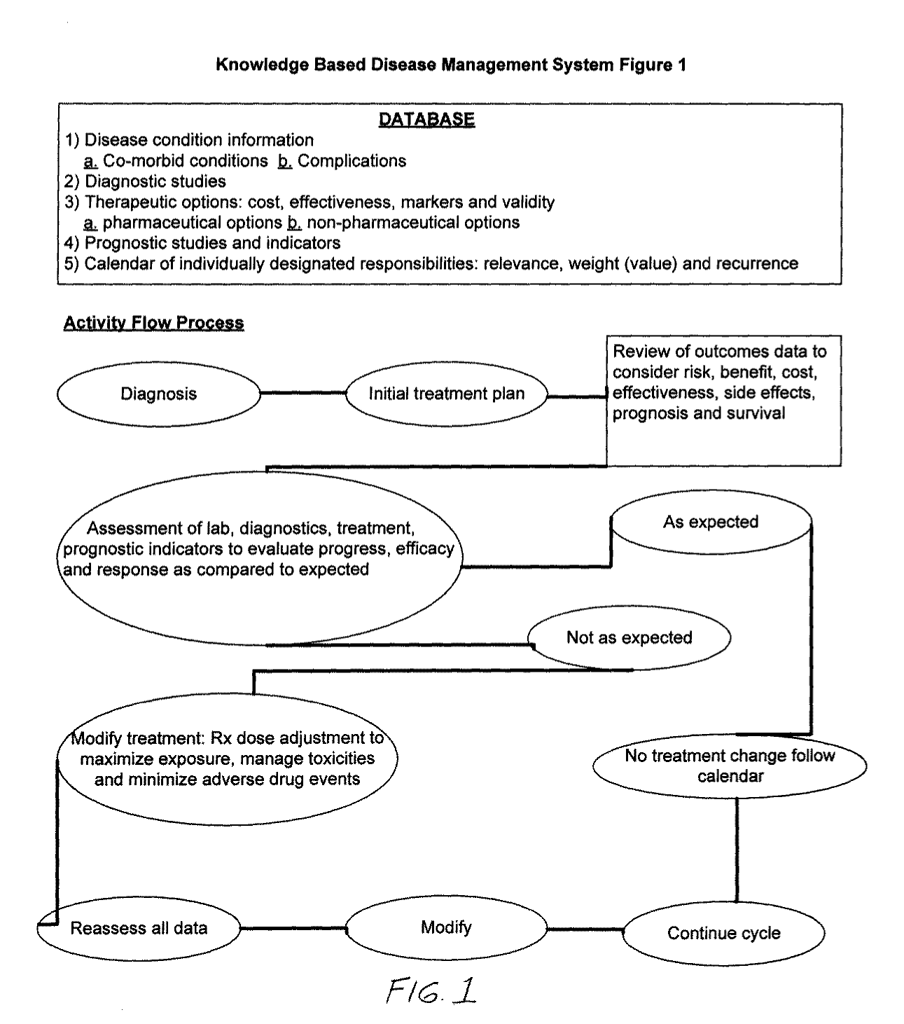

A preferred embodiment of the invention is illustrated in FIG. 1 showing a suitable database and activity flow.

As alluded to hereinabove, complex disease conditions require specialized multi-disciplinary management to assure continuity in the delivery of effective care Beyond the scope of the physician/patient relationship, other entities and persons have entered into the process.

The expert management of pharmacotherapeutic interventions necessitates the introduction of the clinical pharmacy expertise to adequately manage and continually improve this specialized level of healthcare.

The knowledge-based disease management system and method in accordance with the present invention provides the organization, process, and procedure to accomplish this.

Based on a structure which is sequentially related with the initial component references for the individual areas of focus, the secondary mechanism implementation, the third level evaluation, and the fourth level modification, and the final or fifth level re-evaluation, the knowledge-based system and method in accordance with the present Invention provides a replicable, auditable (compliance and persistence), and technically feasible disease management system which can be applied to any disease condition.

The first or reference level contains the current knowledge base of the published data on the disease condition, the drugs available for that condition, the methods of assessing the effectiveness of those drug agents, and the progression of the disease condition.

The secondary level is the delivery of active services on a calendar managed schedule specific to all personnel duties and responsibilities.

The third level is the active assessment of the interventions to measure their effectiveness, patient compliance and disease progression, and report those results in relation to acceptable standards as defined in the first level.

Based on the findings of the third level, the interventions are modified to optimize the desired therapeutic effect or manage the toxic response and then implement it.

Once the modified intervention is delivered, and the results matured, the final or fifth level of re-evaluation is implemented.

Once complete, the system reverts to repeat levels three, four, and five.

Level six is a repository of the system's accumulated knowledge and experience from which outcomes data are reported and compared. The results are reported and compared for individuals with similar characteristics and disease states to assess the likelihood of outcome based upon comparable therapeutic interventions.

As clinical management is a labile, progressive and evolutionary process, each level is reintegrated with the most recent available innovations on as needed or scheduled basis; based upon the dynamic of the phenomenon studied, it may be hourly, daily, weekly, bi-weekly, quarterly or semi-annually, as new findings are made available.

With reference to FIG. 1, it should be noted that the database contains lab studies with type-time to be sampled.

The term “type-time” is intended to mean that the specified lab studies to ensure their relevancy to illustrate the effects of the condition under study, the surrogate markers relationship/latency to the treatment, and that the timing of said sampling be such that the marker has matured and is valid for the decision purpose.

For example, if the patient is given a pharmacotherapeutic agent with a myelosuppressive toxic side effect, the time for the prescriber to assess the effectiveness of the dose would be based on when the patient received it, the relevance and validity of the marker used to the agent given, and how long that particular drug takes to produce the desired therapeutic or toxic effect and impact the marker under observation (in this instance myelosuppression). The full effect “type-time” must be observed to insure that the marker accurately reflects the effect of the dose or treatment.

It should be noted that in the activity flow portion of FIG. 1, there is a section entitled “Review of Outcomes Database to Consider Cost, Effectiveness, and Survival”.

The outcomes database is a relational database which contains data tables of the disease conditions, and their treatments and potential side effects with specific information about the survival, effectiveness, cost and similar variables which can be used to see how the patient may fare at what possible cost, cost effects and impact on prognosis, course and outcome.

For example, if a patient has Stage 111b non-small cell lung cancer, and it is seen that the Carboplatin treatment is 15% more effective than Cisplatin therapy at a cost difference 25% higher, but with a 65% occurrence rate of severely debilitating side effects that may add 80% cost and adversely impact the patient's quality of life that the overall outcome of patients of that particular age and disease progression is a projected lifespan of 15 months, the patient, provider, family, payer and facility can participate in the selection process to choose the best (most acceptable) option with a comprehensive presentation of the data upon which to base their assessment and decision.

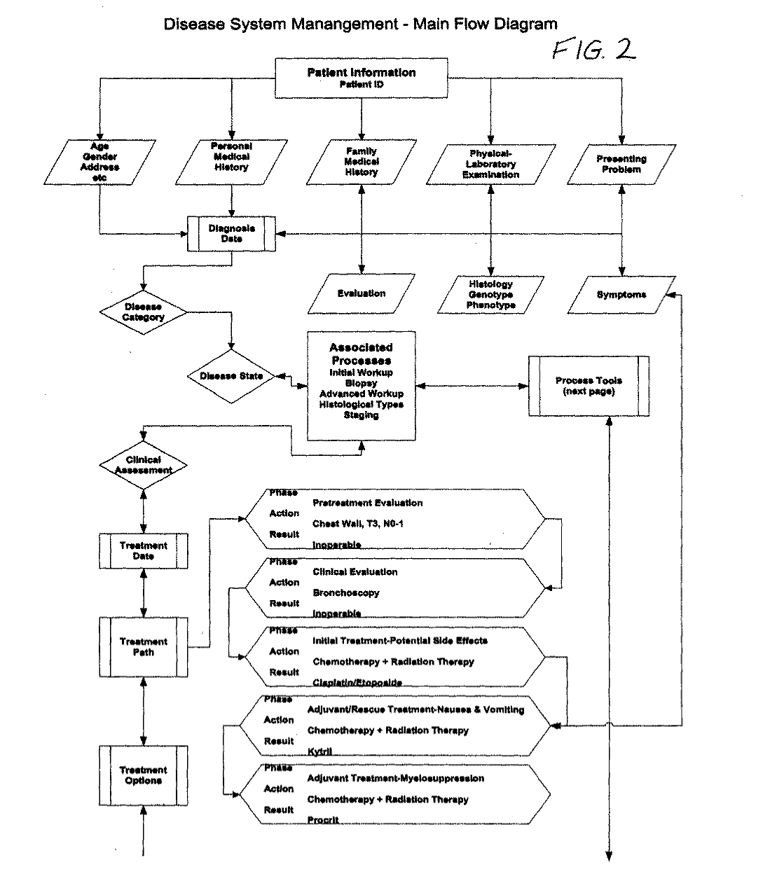

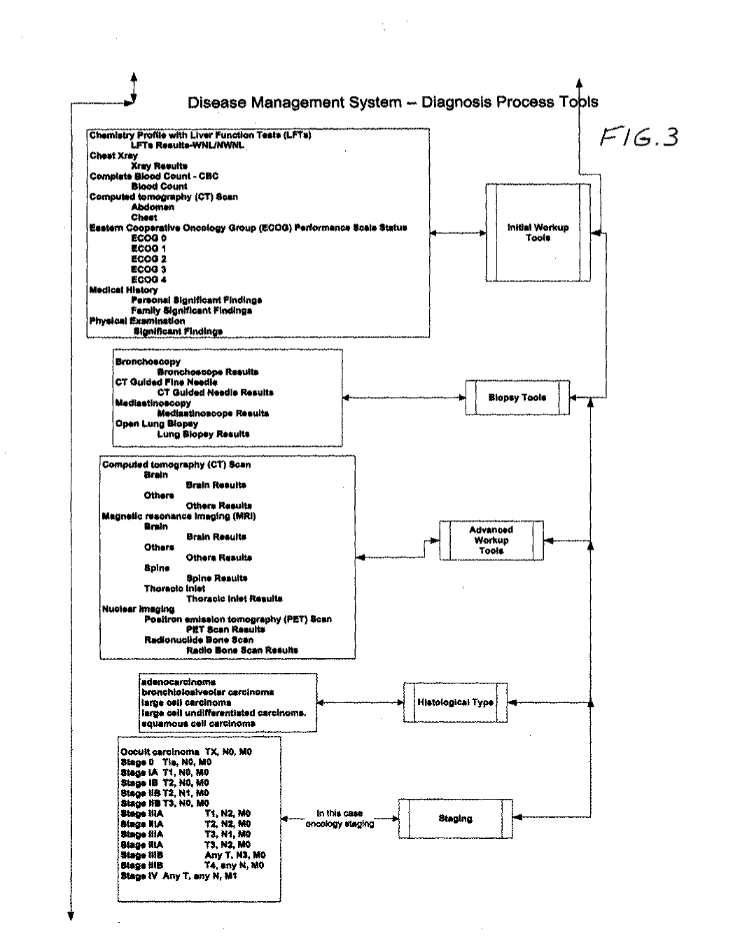

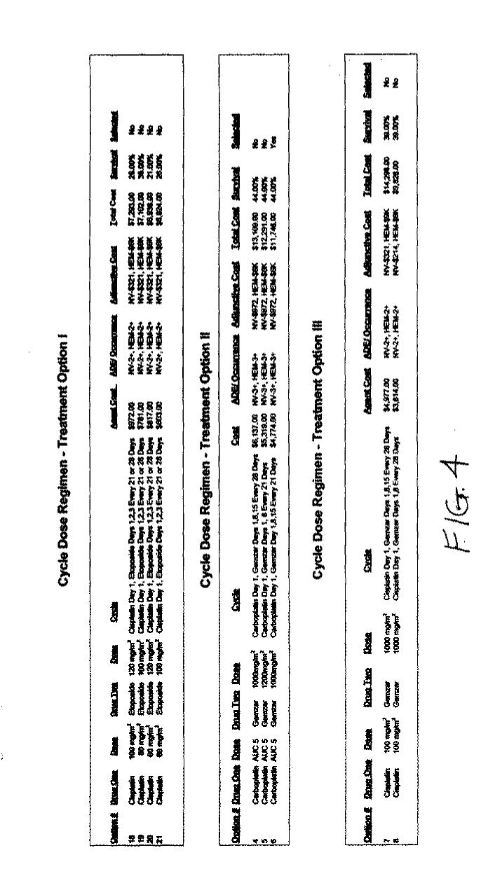

The FIGS. 2, 3 and 4 are presented to show a specific patient example, namely a patient with a non-small cell lung cancer.

The level six repository of accumulated or imported knowledge and experience over time will provide additional metrics to impact the therapeutic decision-making process based upon established practices, outcomes and economic variables.

There has been illustrated in the accompanying drawing and described hereinabove only some embodiments of the present invention which can be utilized and constructed in many different arrangements.

It should be understood that many changes, modifications, variations, and other uses and applications of the present invention will become apparent to those persons skilled in this particular area of technology and to other persons after having been exposed to the present patent specification and accompanying drawings.

Any and all such changes, modifications, variations, and other uses and applications which do not depart from the spirit and scope of the present invention are therefore covered by and embraced within the present patent application and the patent claims set forth hereinbelow.

1. A knowledge-based disease management system to coordinate and improve patient care, comprising the steps of:
providing a first or reference level which includes a knowledge base of published data concerning: a disease condition in question; drugs and agents available for said disease condition; metrics of assessing effectiveness, toxicity and adverse effects of said drugs and agents; progression of said disease condition; potential need for adjuvants, rescue therapies, and dose adjustment of said drugs and agents; an inherent assessment and review mechanism to acquire new options or technologies or discard ineffective options on a monthly basis;
providing a secondary level concerning delivery of active services on a managed schedule;
providing a third level concerning active assessment of interventions to measure effectiveness of said interventions, patient compliance, and progression of said disease condition, and to report results of said active assessment of said interventions in relation to acceptable standards as defined in said first or reference level;
providing a fourth level to modify said interventions based on findings of said third level to optimize a desired therapeutic effect and manage any toxic response;
providing a fifth level to implement said modified interventions;
repeating said third, fourth and fifth levels; and
providing a sixth level as a repository of accumulated knowledge and experience of said system from which outcome data are reported and compared.

2. The knowledge-based disease management system according to claim 1, including:
the step of introducing a combined or multiphasic service provider management systems within each environment services are provided to include; homecare, out-patient clinics, physicians offices, daycare facilities and hospital (acute, chronic and tertiary) as well as rehabilitation facilities, extended care facilities, hospice and group homes.

3. A system according to claim 1, including:
coordination of services from clinical pharmacy, nursing services, physicians and other providers with a payer to adequately manage and continually improve a specialized level of healthcare for said patient and said patient's family.

4. A system according to claim 2, including:
coordination of services from clinical pharmacy, nursing services, physicians and other providers with a payer to adequately manage and continually improve a specialized level of healthcare for said patient and said patient's family.

5. A system according to claim 1, including:
a system interface for all interfacing participants such as, but not limited to, administrative, patient, family, physicians (other providers to include Clinical Pharmacists, Nurse Practitioners, Psychologists and Physician Assistants), professional nurses, vocational nurses, nursing assistants, technical specialists (physical therapists (assistants), respiratory therapists, social workers, vocational counselors, billing specialists), each having its services, timing of provision, results of provision of said services within the expected timeframe to demonstrate the effects (end effect/outcome and surrogate endpoints) of said services and comparison of anticipated results with actual results are among accumulated data points collected, compared, measured and integrated into said knowledge repository of said sixth level.

6. A system according to claim 2, including:
a system interface for all interfacing participants such as, but not limited to, administrative, patient, family, physicians (other providers to include Clinical Pharmacists, Nurse Practitioners, Psychologists and Physician Assistants), professional nurses, vocational nurses, nursing assistants, technical specialists (physical therapists (assistants), respiratory therapists, social workers, vocational counselors, billing specialists), each having its services, timing of provision, results of provision of said services within the expected timeframe to demonstrate the effects (end effect/outcome and surrogate endpoints) of said services and comparison of anticipated results with actual results are among accumulated data points collected, compared, measured and integrated into said knowledge repository of said sixth level.

7. A system according to claim 3, including:
a system interface for all interfacing participants such as, but not limited to, administrative, patient, family, physicians (other providers to include Clinical Pharmacists, Nurse Practitioners, Psychologists and Physician Assistants), professional nurses, vocational nurses, nursing assistants, technical specialists (physical therapists (assistants), respiratory therapists, social workers, vocational counselors, billing specialists), each having its services, timing of provision, results of provision of said services within the expected timeframe to demonstrate the effects (end effect/outcome and surrogate endpoints) of said services and comparison of anticipated results with actual results are among accumulated data points collected, compared, measured and integrated into said knowledge repository of said sixth level.

8. A system according to claim 4, including:
a system interface for all interfacing participants such as, but not limited to, administrative, patient, family, physicians (other providers to include Clinical Pharmacists, Nurse Practitioners, Psychologists and Physician Assistants), professional nurses, vocational nurses, nursing assistants, technical specialists (physical therapists (assistants), respiratory therapists, social workers, vocational counselors, billing specialists), each having its services, timing of provision, results of provision of said services within the expected timeframe to demonstrate the effects (end effect/outcome and surrogate endpoints) of said services and comparison of anticipated results with actual results are among accumulated data points collected, compared, measured and integrated into said knowledge repository of said sixth level.

9. A system according to claim 1, wherein:
the accumulated knowledge of said sixth level supports the assessment of resource allocation and outcome probability based upon the accumulated experience of patients with similar characteristics, therapeutic responses, and prognostic indicators.

10. A system according to claim 2, wherein:
the accumulated knowledge of said sixth level supports the assessment of resource allocation and outcome probability based upon the accumulated experience of patients with similar characteristics, therapeutic responses, and prognostic indicators.

11. A system according to claim 3, wherein:
the accumulated knowledge of said sixth level supports the assessment of resource allocation and outcome probability based upon the accumulated experience of patients with similar characteristics, therapeutic responses, and prognostic indicators.

12. A system according to claim 4, wherein:
the accumulated knowledge of said sixth level supports the assessment of resource allocation and outcome probability based upon the accumulated experience of patients with similar characteristics, therapeutic responses, and prognostic indicators.

13. A system according to claim 5, wherein:
the accumulated knowledge of said sixth level supports the assessment of resource allocation and outcome probability based upon the accumulated experience of patients with similar characteristics, therapeutic responses, and prognostic indicators.

14. A system according to claim 6, wherein:
the accumulated knowledge of said sixth level supports the assessment of resource allocation and outcome probability based upon the accumulated experience of patients with similar characteristics, therapeutic responses, and prognostic indicators.

15. A system according to claim 7, wherein:
the accumulated knowledge of said sixth level supports the assessment of resource allocation and outcome probability based upon the accumulated experience of patients with similar characteristics, therapeutic responses, and prognostic indicators.

16. A system according to claim 8, wherein:
the accumulated knowledge of said sixth level supports the assessment of resource allocation and outcome probability based upon the accumulated experience of patients with similar characteristics, therapeutic responses, and prognostic indicators.

17. The knowledge-based disease management system according to claim 1, including:
the step of introducing a special pharmacy with a payer to adequately manage and continually improve a specialized level of health care for said patient.

18. The knowledge-based disease management system according to claim 2, including:
the step of introducing a provider (patient) coordinated calendar based system of responsibilities system to adequately manage and continually improve a specialized level of health care for said patient.

19. The knowledge-based disease management system according to claim 3, including:
the step of introducing a provider (patient) coordinated calendar based system of responsibilities system to adequately manage and continually improve a specialized level of health care for said patient.

20. The knowledge-base disease management system according to claim 4, including:
the step of introducing a provider (patient) coordinated calendar based system of responsibilities system to adequately manage and continually improve a specialized level of health care for said patient.

21. The knowledge based disease management system according to claim 1, wherein:
said system based upon all said six levels of operation presents patients, providers, payers, manufacturers and facilities with data reporting treatment efficacy, experiences, side effect cost and occurrence, quality of life impact, duration of conditions and services from which new management decisions are made.
